(19) United States
(12) Patent Application Publication
(10) Pub. No.: US 2009/0279730 A1
(43) Pub. Date: Nov. 12, 2009

(54) Shock-Absorbing Apparatus for a Ribbon Microphone Housing

(75) Inventor: Stephen Sank, Tucson, AZ (US)

Correspondence Address: Invent Capture, LLC, 3319 Foxtail Terrace, Fremont, CA, 94536, US

(73) Assignee: H&Y, LLC, Tucson, AZ (US)

(21) Appl. No.: 12/118,751

(22) Filed: May 11, 2008

(51) Int. Cl. H04R 11/04

(52) U.S. Cl. 381/368

(57) ABSTRACT

A ribbon microphone housing incorporates a shock-absorbing apparatus to reduce vibration to a ribbon for noise reduction and high-fidelity electric output signal generation. The ribbon for the ribbon microphone housing is typically made of a thin corrugated strip of aluminum. The shock-absorbing apparatus utilizes spring elements to suspend a ribbon microphone frame in air. The spring elements isolate the ribbon contained in a ribbon frame from vibration, rumble, and shock exerted to the ribbon microphone housing which encloses both the ribbon and the ribbon frame. The shock-absorbing apparatus also uses an electrically-conductive spring element configured to carry the electric output signal from an electrode connected to one end of the ribbon to one or more transformers for further signal processing.

### BACKGROUND

In the first half of the 20^{th} century, ribbon microphones once dominated commercial broadcasting and recording industries as a preferred high-end microphone technology. First developed by Dr. Harry F. Olson of RCA corporation in the late 1920's, Ribbon microphones widely commercialized in the 1930's exhibited superior frequency responses and higher-fidelity output signals compared to many condenser microphones of the time.

A ribbon microphone typically uses a thin piece of metal immersed in magnetic field generated by surrounding magnets. The thin piece of metal is generally called a “ribbon” and is often corrugated to achieve wider frequency response and fidelity. Ribbon microphones became vastly popular and became a primary broadcasting and recording microphone until mid-1960's.

However, the classic ribbon microphone architecture was susceptible to significant disadvantages. First, a typical ribbon microphone contained a fragile ultra-thin ribbon, typically made of corrugated aluminum, which could break easily if the ribbon microphone casing was subject to a gust of air through its microphone windscreen. Second, most ribbon microphones could not produce as high output signal level as condenser or dynamic microphones. The lack of high output signal level for ribbon microphones usually required careful pre-amplification matching and tuning, which was cumbersome and contributed to reduced ruggedness and reliability compared to condenser and dynamic microphones.

By the mid-1960's, dynamic moving-coil microphones (i.e. coil wire on a diaphragm suspended over a magnetic field) and condenser microphones (i.e. capacitor microphones) evolved technologically for higher sensitivity and signal-to-noise ratio (SNR) to compete effectively against ribbon microphones. For example, improved condenser microphones exhibited substantially higher output signal level than ribbon microphones, thereby simplifying pre-amplification process and improving reliability of recording or broadcasting equipment.

Although a typical condenser microphone had the tendency of exaggerating upper frequency ranges whenever inherent harmonic resonances occurred in a diaphragm of the microphone, the exaggerated upper frequency was actually preferred by some while recording industry started using analog tape mediums for audio recording. Most analog tapes suffered generational signal losses and could not accurately capture high-frequency ranges, which made the use of condenser microphone-based recording equipment more acceptable. Similarly, although dynamic moving-coil microphones fundamentally possessed higher resistivity to sound waves than ribbon microphones, improved dynamic moving-coil microphones provided ways to compensate for a relatively low high-frequency response. Therefore, by the mid-1960's, most ribbon microphones were rapidly replaced by more portable, rugged, and user-friendly condenser and dynamic moving-coil microphones. By the end of that decade, ribbon microphones were widely considered obsolete.

However, despite several drawbacks as mentioned above, ribbon microphones possess fundamental advantages as recording and broadcasting industry become fully adjusted to the digital era. As Compact Discs and solid-state non-volatile memory (e.g. NAND flash memory) became recording media of choice for highly digitized recording and broadcasting equipment, the high-frequency exaggeration and distortion provided by condenser microphones were no longer desirable. Many audio engineers and music lovers began to favor more natural and linear reproduction of sound, which meant that ribbon microphone's fundamentally higher fidelity in higher frequencies received attention once again. Ribbon microphones also provide a generally richer and fuller sound reproduction compared to condenser and dynamic moving-coil microphones with digital audio recording and broadcasting equipment. In recent years, there has been a resurgence of demand for retrofitted ribbon microphones of yore and a need for newly-designed ribbon microphones, especially in the high-end audio industry.

For a newly-designed ribbon microphone, it is desirable to isolate a ribbon (i.e. typically made of thin corrugated piece of aluminum) from a ribbon housing's vibrations or oscillations caused by an external shock or rumble. Vibrations or oscillations of the ribbon housing can introduce unnecessary noise to the ribbon and degrade the quality of an output signal from the ribbon. Furthermore, for the newly-designed ribbon microphone, it is also desirable to simplify the output signal wiring of the ribbon for higher durability, manufacturing cost, and vibration-reduction. Therefore, a novel shock-absorbing apparatus addressing at least some of these issues is desirable.

### SUMMARY

A shock-absorbing apparatus inside a ribbon microphone housing is disclosed. The shock-absorbing apparatus comprises a ribbon microphone frame suspended at least partly in air by one or more spring elements, wherein the one or more spring elements are configured to reduce shock energy translated to a ribbon inside the ribbon microphone frame upon receipt of an external mechanical shock, the ribbon configured to generate electric output signals by reacting to sound waves, wherein the ribbon is located inside the ribbon microphone frame and at least partly immersed in a magnetic field generated by a magnet, and an electrically-conductive spring element electrically and operatively connected to one end of the ribbon to one or more transformers, wherein the electrically-conductive spring element is configured to transmit the electric output signals to the one or more transformers.

In addition, a ribbon microphone housing containing a shock-absorbing apparatus is disclosed. The ribbon microphone housing comprises a ribbon microphone frame suspended at least partly in air by one or more spring elements, wherein the one or more spring elements are configured to reduce shock energy translated to a ribbon inside the ribbon microphone frame upon receipt of an external mechanical shock, the ribbon configured to generate electric output signals by reacting to sound waves, wherein the ribbon is located inside the ribbon microphone frame and at least partly immersed in a magnetic field generated by a magnet, an electrically-conductive spring element electrically and operatively connected to one end of the ribbon to one or more transformers, wherein the electrically-conductive spring element is configured to transmit the electric output signals to the one or more transformers, a first electrode physically connected to the one end of the ribbon and a second electrode operatively connected to another end of the ribbon, wherein the first electrode is configured to transmit the electric output signal from the ribbon to the electrically-conductive spring element, and the second electrode is connected to an electrical ground, and the one or more transformers configured to receive the electric output signals generated by the ribbon to produce a desirable electrical voltage and/or gain characteristics and an appropriate impedance matching to the ribbon while maintaining a wide frequency response.

### BRIEF DESCRIPTION OF DRAWINGS

FIG. 1 shows an internal top-view of a shock-absorbing apparatus for a ribbon microphone housing in accordance with an embodiment of the invention.

FIG. 2 shows another internal view of a shock-absorbing apparatus operatively connected to a transformer block in accordance with an embodiment of the invention.

FIG. 3 shows a corrugated ribbon surrounded by magnets and pole pieces in accordance with an embodiment of the invention.

FIG. 4 shows a front-lateral view of an exterior casing of a ribbon microphone with a shock-absorbing apparatus for a ribbon microphone housing inside the exterior casing in accordance with an embodiment of the invention.

FIG. 5 shows a side view of an exterior casing of a ribbon microphone with a shock-absorbing apparatus for a ribbon microphone housing inside the exterior casing in accordance with an embodiment of the invention.

FIG. 6 shows a bottom view of an exterior casing of a ribbon microphone with a shock-absorbing apparatus for a ribbon microphone housing inside the exterior casing in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention relate to a ribbon microphone. More specifically, an embodiment of the invention relates to a shock-absorbing apparatus for a ribbon microphone housing, wherein the shock-absorbing apparatus reduces vibration translated to a ribbon (e.g. a thin corrugated piece of aluminum) and a ribbon microphone frame containing the ribbon when an external shock is exerted to the ribbon microphone housing.

Another embodiment of the invention relates to utilizing one or more elastic spring elements to suspend at least a portion of the ribbon microphone frame in air. The use of elastic spring elements enables the ribbon microphone frame containing the ribbon to absorb at least a portion of an external shock when an external force (e.g. the ribbon microphone being knocked out to the ground, banging against an external object, external rumble, vibration, and etc.) is about to be transmitted to the ribbon itself. The shock-absorption by the ribbon microphone frame reduces unnecessary vibration to the ribbon, which results in higher-fidelity output signal generation by the ribbon with a reduction in unwanted noise.

Another embodiment of the invention relates to an electrically-conductive spring element which conducts an electric output signal from the ribbon to a transformer block, thereby simplifying wiring scheme between the ribbon and a transformer block.

Yet another embodiment of the invention relates to a ribbon microphone housing containing a shock-absorbing apparatus, wherein the ribbon microphone housing further includes a transformer block configured to produce a desirable electrical voltage-gain characteristics and an appropriate impedance matching to a ribbon inside a ribbon microphone frame.

Furthermore, one objective of the invention is to provide a shock-absorbing apparatus using one or more elastic spring elements attached to a ribbon microphone housing and a ribbon microphone frame containing a ribbon.

Another objective of the invention is to provide an electrically conductive spring element configured to transmit an output signal from the ribbon to simplify wiring requirements of the ribbon.

Yet another objective of the invention is to provide a fabric screen covering a substantial portion of a ribbon inside a ribbon microphone frame, wherein the fabric screen provides a protective layer for the ribbon from external elements while enabling the ribbon to achieve a high frequency response to the sound waves.

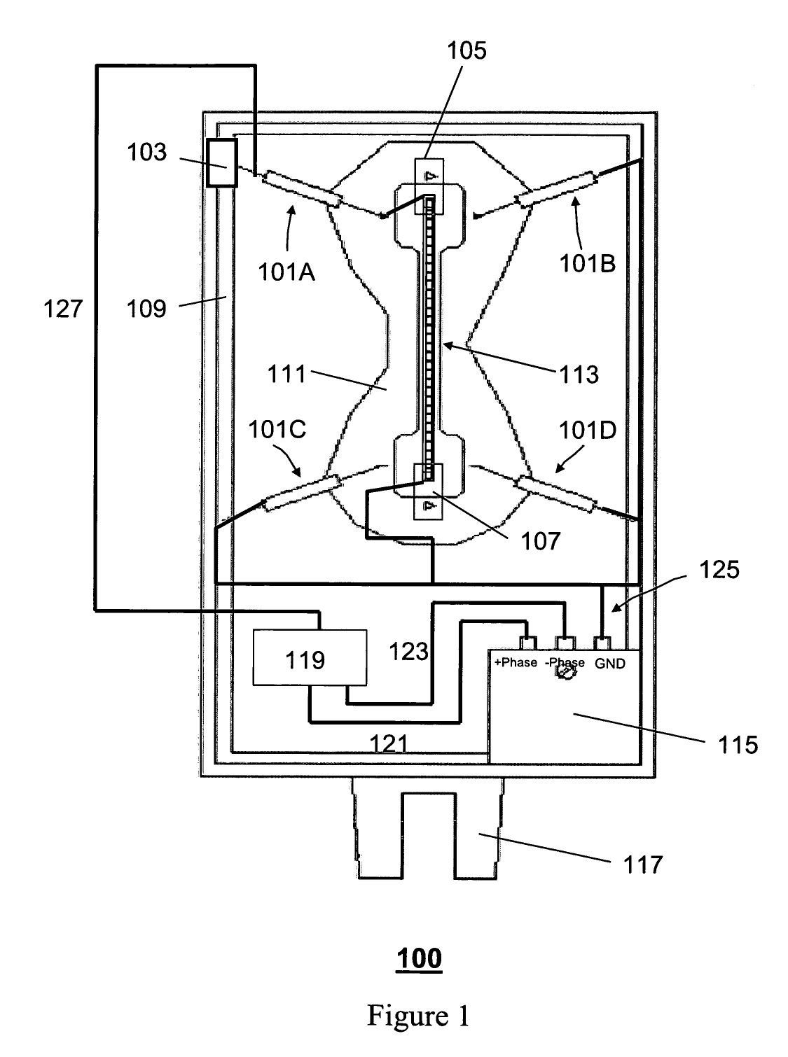

FIG. 1 shows an internal top-view of a shock-absorbing apparatus (100) for a ribbon microphone housing (109) in accordance with an embodiment of the invention. As shown in FIG. 1, a ribbon (113) typically made of thin corrugated aluminum is inside a ribbon microphone frame (111) in one embodiment of the invention. In this particular embodiment, a first clamp (105) holds a first end of the ribbon (113) and a first portion of the ribbon microphone frame (111) together, and a second clamp (107) holds a second end of the ribbon (113) and a second portion of the ribbon microphone frame (111) together.

The shock-absorbing apparatus (100) of FIG. 1 utilizes four spring elements (101A, 101B, 101C, 101D), each of which connects a corner of the ribbon microphone frame (111) to a sidewall of the ribbon microphone housing (109). In this particular embodiment of the invention, the ribbon microphone frame (111) and the ribbon (113) contained inside the ribbon microphone frame (111) are suspended in air by the four spring elements (101A, 101B, 101C, 101D).

It is important to note that the spring elements (101A, 101B, 101C, 101D) provide at least some shock absorption to the ribbon microphone frame (111) when an external shock or vibration is exerted to the shock-absorbing apparatus (100). This resulting shock absorption translates to a higher-fidelity signal output and noise reduction for the ribbon (113). In essence, the shock-absorbing apparatus (100) of the present invention provides some measure of isolation of the ribbon (113) and the ribbon microphone frame (111) from a ribbon housing's (109) vibrations or oscillations caused by an external shock or rumble. Because vibrations, rumble, or oscillations to the ribbon housing (109) can introduce unnecessary noise and degrade the quality of an output signal from the ribbon if left untreated, an effective measure of vibration dampening using the shock-absorbing apparatus (100) in accordance with an embodiment of the present invention provides substantial advantages over prior art.

Continuing with FIG. 1, one of the four spring elements (101A, 101B, 101C, 101D) is configured to transmit electric output signals from one end of the ribbon (113). In one embodiment of the invention, a top-left spring element (101A) is an electrically-conductive spring element. The top-left spring element (101A) is electrically connected to a top end of the ribbon (113) to carry electrical output signals from the ribbon (113) to a transformer block (119) via electrical connection (127). The top-left spring element (101A) is also electrically insulated (i.e. using an electrical insulator (103)) from the ribbon housing (109) because the ribbon housing (109) is electrically grounded in this example. A common embodiment of the invention will also electrically ground the remaining three spring elements (101B, 101C, 101D), as shown by three electrical connections to the ground (125).

Allowing at least one (101A) of the spring elements to conduct electrical signals from the ribbon (113) as shown by way of example in FIG. 1 provides several key benefits to ribbon microphone design. An electrically conductive spring element operatively connected to one end of a ribbon simplifies the output signal wiring of the ribbon while also being utilized as part of the shock-absorbing apparatus (100), because less wires are needed to connect the ribbon (113) to a transformer block (119). Simplifying wiring of the ribbon (113) to the transformer block (119) also reduces unwanted vibration and noise for even higher-fidelity electric output signal generation from the ribbon (113). The embodiment of the invention as shown in FIG. 1 is a preferred embodiment (i.e. inventor's best mode) of the invention.

Continuing with FIG. 1, the ribbon microphone housing (109) can also include electrical connectors (115) configured to receive an external power supply (i.e. especially in case of an active microphone with an embedded pre-amplification) and/or transmit the electric output signals originally generated by the ribbon (113) to an external pre-amplifier or an amplifier. In one embodiment of the invention, the electrical connectors (115) comprise a positive phase signal (or in-phase) connector, a negative phase signal (or out-of-phase) connector, and a ground connector, as shown in FIG. 1. In order for the ribbon (113) to generate the electric output signals, the ribbon (113) is generally immersed in magnetic fields generated by one or more magnets surrounding the ribbon (113). In one embodiment of the invention, several bar-type magnets are part of the ribbon microphone frame (111), wherein the bar-type magnets generate magnetic fields surrounding the ribbon (113). Optionally, a tensile pressure on the ribbon (113) can be adjusted with a tensioning screw located near one end of the ribbon (113). Furthermore, a substantial portion of the ribbon (113) can be covered by a soft fabric screen (e.g. silk) to provide a protective layer from external elements while still allowing the ribbon (113) to achieve a high frequency response to sound waves.

Continuing with FIG. 1, a microphone stand connector (117) is attached to a bottom surface of the ribbon microphone housing (109) for an angle-adjustable connection to a microphone stand. It should be noted that the novelty of the present invention is related to the use of the spring elements (101A, 101B, 101C, 101D) and transmission of the electric output signal from the ribbon (113) using at least one spring element (e.g. 101A) as part of the shock-absorbing apparatus (100).

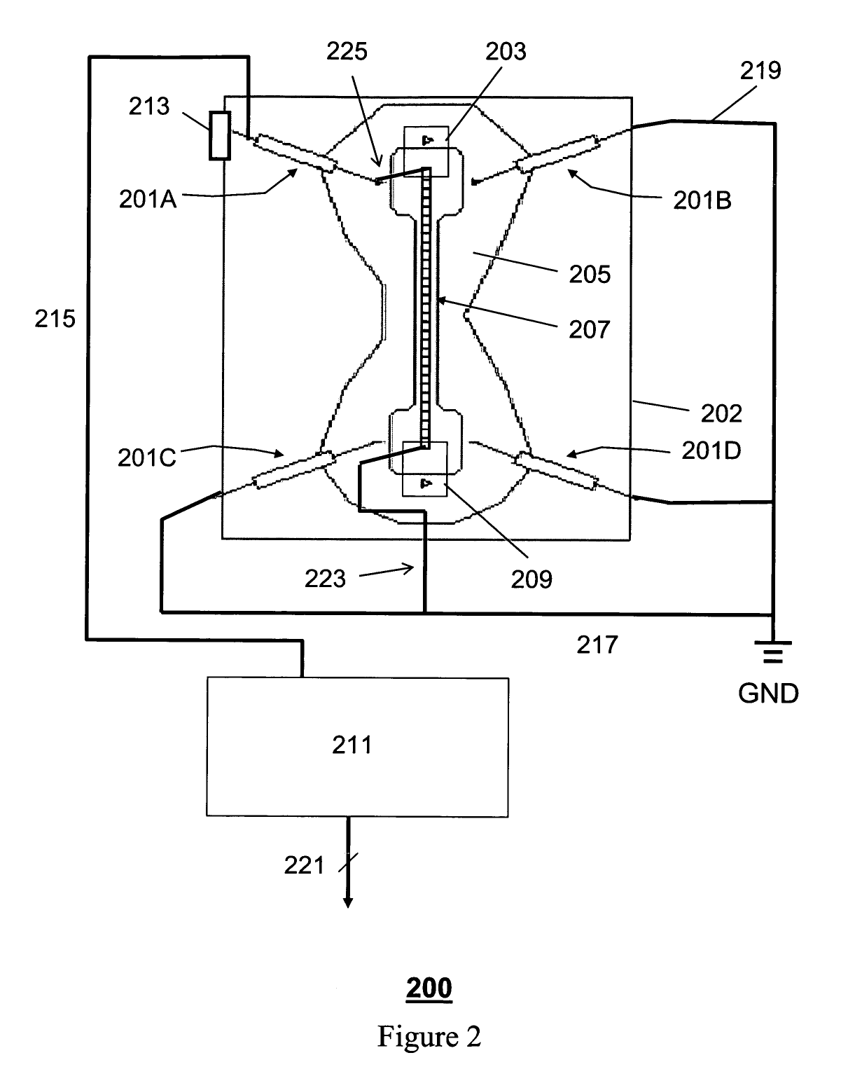

FIG. 2 shows another internal view (200) of a shock-absorbing apparatus (202) operatively connected to a transformer block (211) in accordance with an embodiment of the invention. Similar to a preferred embodiment of FIG. 1, the shock-absorbing apparatus (202) of FIG. 2 uses four spring elements (201A, 201B, 201C, 201D) to suspend a ribbon microphone frame (205) in air.

In one embodiment of the invention, a ribbon (207) typically made of a thin corrugated piece of aluminum is affixed to the ribbon microphone frame (205) by a first clamp (203) and a second clamp (209). The ribbon (207) is also at least partially immersed in magnetic fields generated by one or more nearby magnets in the ribbon microphone frame (205).

In order to transmit electric output signals of the ribbon (207) generated by sound pressure waves for further processing, a first electrode (225) is operatively connected to a first end (e.g. top) of the ribbon (207) to an output signal path (215) via electrical conduction through an electrically-conductive spring element (e.g. 201A), which is electrically insulated from the shock-absorbing apparatus (202) by an electrical insulator (213). A second electrode (223) is operatively connected to a second end (e.g. bottom) of the ribbon (207) to the ground (217). The first electrode (225), the electrically-conductive spring element (201A), and the output signal path (215) are also operatively connected to a transformer block (211) to carry the output signals from the ribbon (207) to the transformer block (211). In one embodiment of the invention, the remaining spring elements (201B, 201C, 201D) are electrically grounded along with the second electrode (223) to the ribbon (207).

Continuing with FIG. 2, the transformer block (211) is configured to produce a desirable electrical voltage-gain characteristics and an appropriate impedance matching to the ribbon (207) while maintaining a high frequency response. The transformer block (211) generally uses a multiple number of transformers and could operate as a passive circuitry without requiring any power source or as an active circuitry with an internal or external power source. The output signals (221) from the transformer block (211) can be a positive phase signal and a negative phase signal which typically exhibit higher voltage than the original electric output signal. The output signals (221) from the transformer block are then typically transmitted to an external pre-amplifier, an amplifier, or other electrical equipment for recording or reproduction of sound.

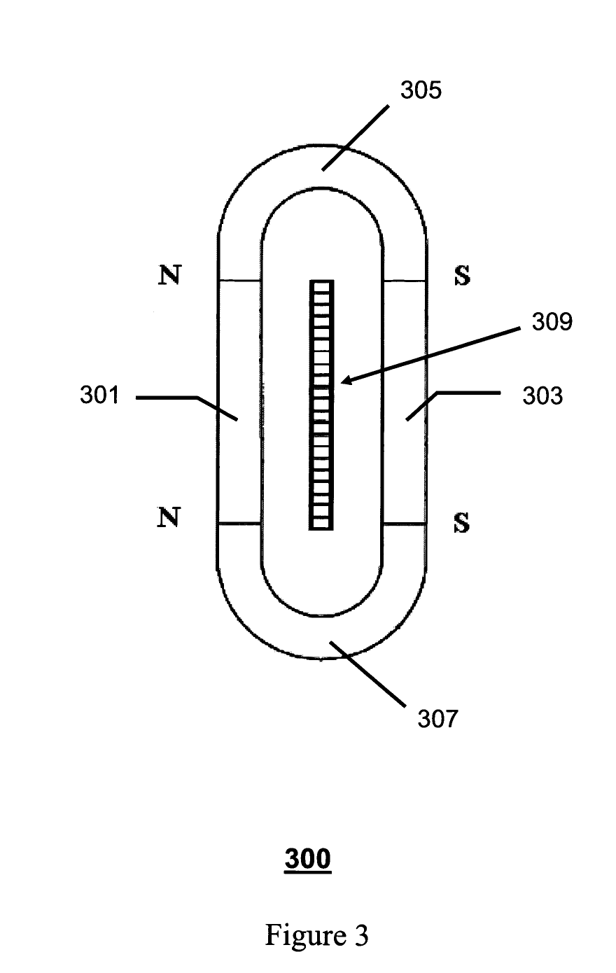

FIG. 3 shows a ribbon (309) surrounded by horseshoe-shaped magnets (305, 307) and pole pieces (301, 303) in accordance with an embodiment of the invention. In one embodiment of the invention, the ribbon (309) is a thin corrugated aluminum piece immersed in magnetic fields generated by the horseshoe-shaped magnets (305, 307). When a sound wave (i.e. acoustic pressure wave) causes the ribbon (309) to vibrate, a voltage is induced along the length of the ribbon (309) which is theoretically proportional to the intensity and frequency of the sound wave. In one or more embodiments of the invention, the horseshoe-shaped magnets (305, 307) and the pole pieces (301, 303) are used to produce electric output signals from the ribbon (309), and the electric output signals are transmitted by at least one electrode at opposing ends of the ribbon (309) for further signal processing by transformers and pre-amplification circuitry. It should be noted that there are other geometrical arrangements of magnets and ribbons to induce electrical output signals for a ribbon microphone. The particular configuration (300) of FIG. 3 is only one of the many types of ribbon microphone architectures and by no means limits the application of a shock-absorbing apparatus for a ribbon microphone housing in accordance with an embodiment of the present invention.

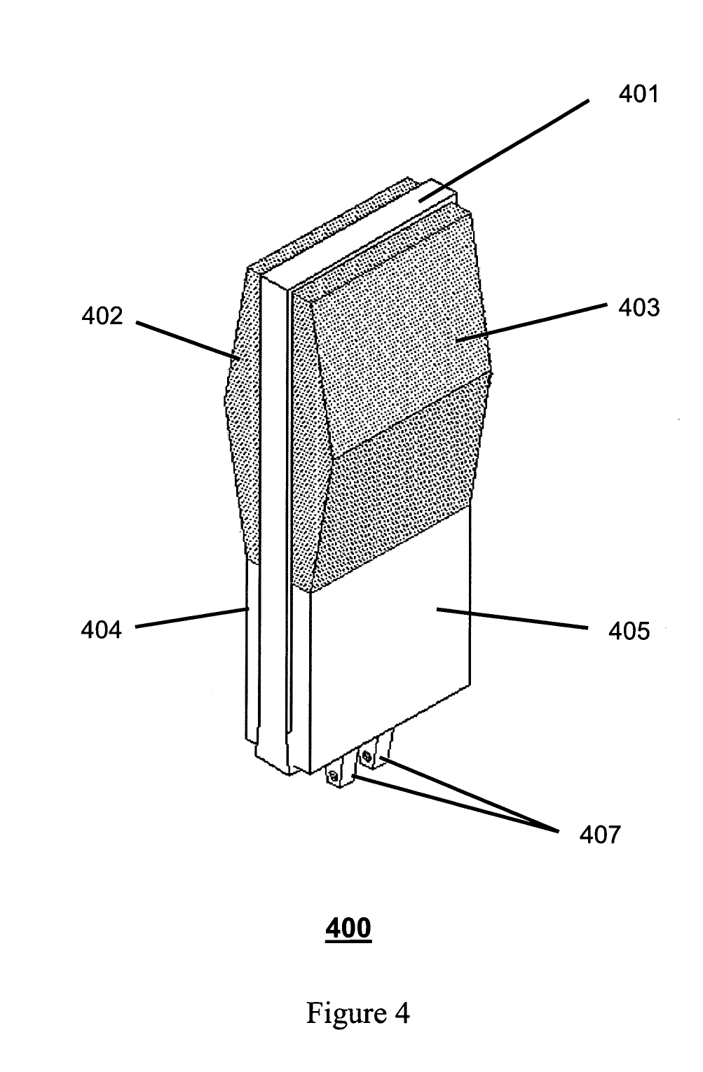

FIG. 4 shows a front-lateral view of an exterior casing of a ribbon microphone (400) with a shock-absorbing apparatus for a ribbon microphone housing inside the exterior casing in accordance with an embodiment of the invention. In this particular exterior casing, a first microphone body panel (405) and a first microphone exterior screen (403) are attached to a second microphone body panel (404) and a second microphone exterior screen (402) by a microphone exterior side molding (401). The first microphone exterior screen (403) and the second microphone exterior screen (402) are configured to transmit sound waves into the ribbon inside the exterior casing to induce generation of electrical signals for recording or broadcasting of the sound waves. A microphone stand connecter (407) at the bottom surface of the ribbon microphone (400) can be used for an angle-adjustable connection to a microphone stand. In one embodiment of the invention, if the ribbon microphone (400) is subject to an external shock, the shock-absorbing apparatus as described in FIG. 1 and FIG. 2 can reduce unwanted noise, improve frequency response, and achieve higher-fidelity electric output signal generation. The particular exterior shape of the ribbon microphone (400) of FIG. 4 is only one of the many types of exterior casings and by no means limits the application of a shock-absorbing apparatus for a ribbon microphone housing in accordance with an embodiment of the present invention.

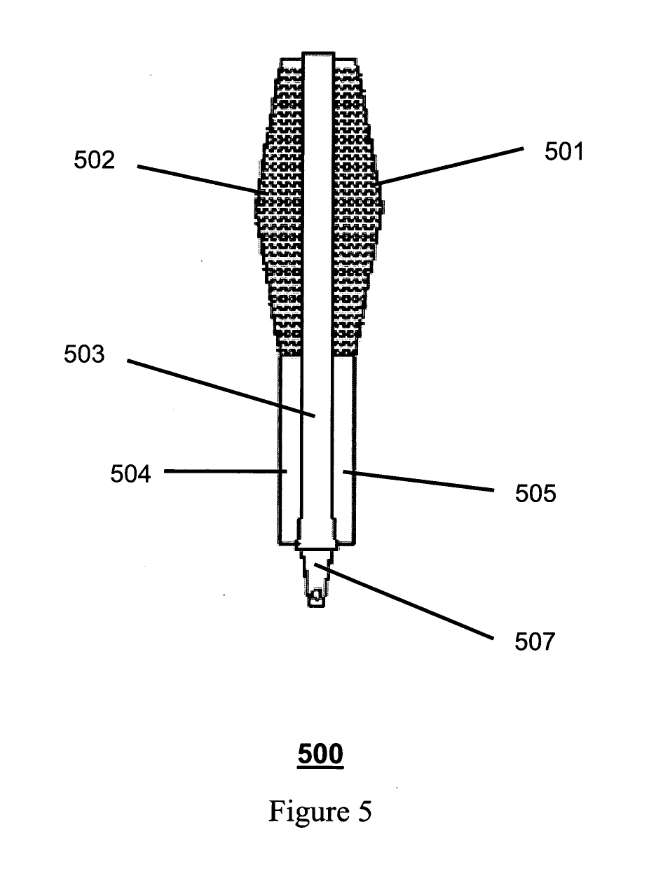

FIG. 5 shows a side view of an exterior casing of a ribbon microphone (500) with a shock-absorbing apparatus for a ribbon microphone housing inside the exterior casing in accordance with an embodiment of the invention. In this particular exterior casing, a first microphone body panel (505) and a first microphone exterior screen (501) are attached to a second microphone body panel (504) and a second microphone exterior screen (502) by a microphone exterior side molding (503). The first microphone exterior screen (501) and the second microphone exterior screen (502) are configured to transmit sound waves into the ribbon inside the exterior casing to induce generation of electrical output signals for recording or broadcasting of the sound waves. A microphone stand connecter (507) at the bottom surface of the ribbon microphone (500) can be used for an angle-adjustable connection to a microphone stand. In one embodiment of the invention, if the ribbon microphone (500) is subject to an external shock, the shock-absorbing apparatus as described in FIG. 1 and FIG. 2 can reduce unwanted noise, improve frequency response, and achieve higher-fidelity electric output signal generation.

The particular exterior shape of the ribbon microphone (500) of FIG. 5 is only one of the many types of exterior casings and by no means limits the application of a shock-absorbing apparatus for a ribbon microphone housing in accordance with an embodiment of the present invention.

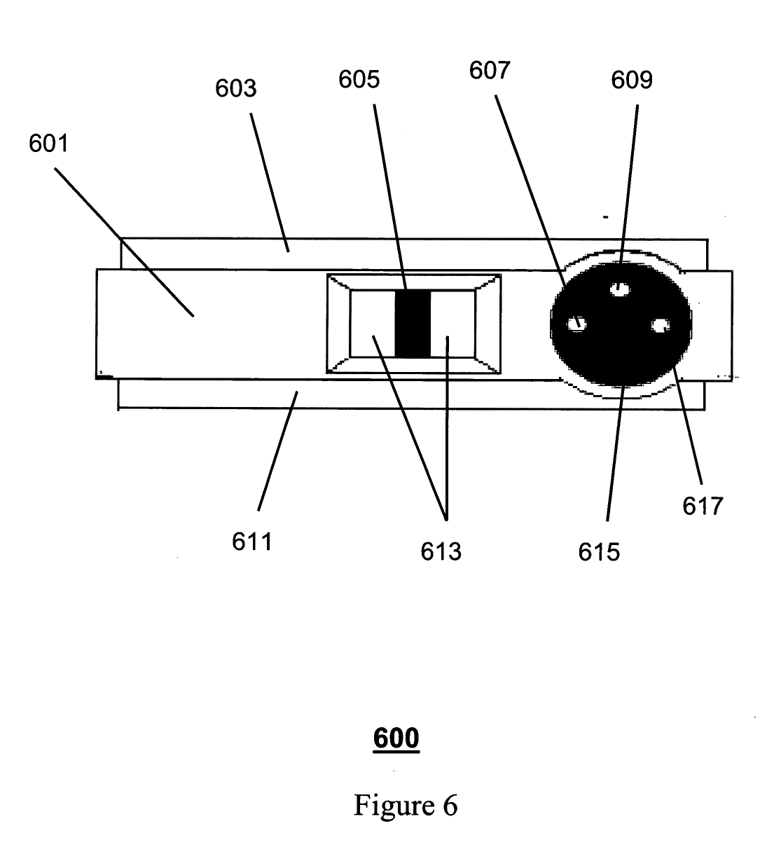

FIG. 6 shows a bottom view of an exterior casing of a ribbon microphone (600) with a shock-absorbing apparatus for a ribbon microphone housing inside the exterior casing in accordance with an embodiment of the invention. In one embodiment of the invention, a first microphone body panel (603) is attached to a second microphone body panel (611) by a microphone exterior molding (601). A microphone stand connecter (613) at the bottom surface of the ribbon microphone (600) can be used for an angle-adjustable connection to a microphone stand. In one particular embodiment as shown in FIG. 6, a microphone stand connector groove (605) is also used to dock the ribbon microphone (600) to a microphone stand. In one embodiment of the invention, the ribbon microphone (600) uses a three conductor microphone cable connector (615). In one embodiment of the invention, two pins (607, 609) can form a differential signal path for the electric output signal from the ribbon microphone (600) and a third pin (617) serves as an electrical ground contact. In one particular example, the leftmost pin (607) can serve as a positive-phase signal connector and the middle pin (609) can serve as a negative-phase signal connector. The three conductor microphone cable connector (615) can also be used to supply power into the ribbon microphone (600) if active circuitry (e.g. a pre-amplifier) inside the ribbon microphone (600) is used. For instance, a first pin (607) can carry an in-phase signal and a second pin (609) can carry an out-of-phase signal.

The present invention provides key benefits to conventional ribbon microphone designs. First, a shock-absorbing apparatus for a ribbon microphone housing disclosed in the present invention reduces vibration translated to a ribbon (e.g. a thin corrugated piece of aluminum) and a ribbon microphone frame containing the ribbon when an external shock is exerted to the ribbon microphone housing. By utilizing one or more elastic spring elements to suspend at least a portion of the ribbon microphone frame in air, the present invention enables the ribbon microphone frame containing the ribbon to absorb at least a portion of an external shock when an external force (e.g. the ribbon microphone being knocked out to the ground, banging against an external object, external rumble, vibration, and etc.) is about to be transmitted to the ribbon itself. The shock-absorption by the ribbon microphone frame reduces unnecessary vibration to the ribbon, which results in higher-fidelity output signal generation by the ribbon with a reduction in unwanted noise.

An additional significant advantage of the present invention is an electrically-conductive spring element which conducts an electric output signal from the ribbon to a transformer block, thereby simplifying wiring scheme between the ribbon and a transformer block compared to existing ribbon microphone designs. The electrically conductive spring element operatively connected to one end of a ribbon simplifies the output signal wiring of the ribbon while also being utilized as part of the shock-absorbing apparatus. Because any complicated wiring to the ribbon can be another source of vibration and reduction in fidelity, using the electrically-conductive spring element as a signal path for the electric output signal from the ribbon to a transformer block reduces unwanted vibration and noise for even higher-fidelity electric output signal generation from the ribbon.

Furthermore, an additional benefit of the present invention is related to a fabric screen covering a substantial portion of a ribbon inside a ribbon microphone frame, wherein the fabric screen provides a protective layer for the ribbon from external elements while enabling the ribbon to achieve a good frequency response to sound waves.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A shock-absorbing apparatus inside a ribbon microphone housing, the shock-absorbing apparatus comprising:
a ribbon microphone frame suspended at least partly in air by one or more spring elements, wherein the one or more spring elements are configured to reduce shock energy translated to a ribbon inside the ribbon microphone frame upon receipt of an external mechanical shock;
the ribbon configured to generate electric output signals by reacting to sound waves, wherein the ribbon is located inside the ribbon microphone frame and at least partly immersed in a magnetic field generated by a magnet; and
an electrically-conductive spring element electrically and operatively connected to one end of the ribbon to one or more transformers, wherein the electrically-conductive spring element is configured to transmit the electric output signals to the one or more transformers.

2. The shock-absorbing apparatus of claim 1, wherein the ribbon is made of a thin piece of corrugated aluminum.

3. The shock-absorbing apparatus of claim 1, further comprising an electrical insulator placed between the ribbon microphone frame and one end of the electrically-conductive spring element, wherein the ribbon microphone frame is electrically grounded.

4. The shock-absorbing apparatus of claim 1, further comprising a first electrode physically connected to the one end of the ribbon and a second electrode operatively connected to another end of the ribbon, wherein the first electrode is configured to transmit the electric output signal from the ribbon to the electrically-conductive spring element, and the second electrode is connected to an electrical ground.

5. The shock-absorbing apparatus of claim 1, further comprising a first clamp holding a first portion of the ribbon microphone frame and a first portion of the ribbon together.

6. The shock-absorbing apparatus of claim 5, further comprising a second clamp holding a second portion of the ribbon microphone frame and a second portion of the ribbon together.

7. The shock-absorbing apparatus of claim 1, wherein a first end of each of the one or more spring elements is connected to the ribbon microphone housing and a second end of each of the one or more spring elements is connected to the ribbon microphone frame.

8. The shock-absorbing apparatus of claim 1, further comprising a tensioning screw located near one end of the ribbon, wherein the tensioning screw is configured to change a tensile pressure on the ribbon.

9. The shock-absorbing apparatus of claim 1, wherein the magnet generating the magnetic field for the ribbon is a bar-type or horseshoe-shaped magnet partially surrounding a first end of the ribbon.

10. The shock-absorbing apparatus of claim 1, further comprising a fabric screen covering a substantial portion of the ribbon, wherein the fabric screen provides a protective layer for the ribbon from external elements and still enables the ribbon to achieve a wide frequency response to the sound waves.

11. The shock-absorbing apparatus of claim 10, wherein the fabric screen is made of silk.

12. A ribbon microphone housing containing a shock-absorbing apparatus, the ribbon microphone housing comprising:
a ribbon microphone frame suspended at least partly in air by one or more spring elements, wherein the one or more spring elements are configured to reduce shock energy translated to a ribbon inside the ribbon microphone frame upon receipt of an external mechanical shock;
the ribbon configured to generate electric output signals by reacting to sound waves, wherein the ribbon is located inside the ribbon microphone frame and at least partly immersed in a magnetic field generated by a magnet;
an electrically-conductive spring element electrically and operatively connected to one end of the ribbon to one or more transformers, wherein the electrically-conductive spring element is configured to transmit the electric output signals to the one or more transformers;
a first electrode physically connected to the one end of the ribbon and a second electrode operatively connected to another end of the ribbon, wherein the first electrode is configured to transmit the electric output signal from the ribbon to the electrically-conductive spring element, and the second electrode is connected to an electrical ground; and
the one or more transformers configured to receive the electric output signals generated by the ribbon to produce a desirable electrical voltage and/or gain characteristics and an appropriate impedance matching to the ribbon while maintaining a wide frequency response.

13. The ribbon microphone housing of claim 12, wherein the ribbon is made of a thin piece of corrugated aluminum.

14. The ribbon microphone housing of claim 12, further comprising a first clamp holding a first portion of the ribbon microphone frame and a first portion of the ribbon together, and a second clamp holding a second portion of the ribbon microphone frame and a second portion of the ribbon together.

15. The ribbon microphone housing of claim 12, further comprising an electrical connector unit configured to provide a two-phase electrical signal path and an electrical ground.

16. The ribbon microphone housing of claim 12, wherein a first end of each of the one or more spring elements is connected to the ribbon microphone housing and a second end of each of the one or more spring elements is connected to the ribbon microphone frame.

17. The ribbon microphone housing of claim 12, further comprising a tensioning screw located near one end of the ribbon, wherein the tensioning screw is configured to change a tensile pressure on the ribbon.

18. The ribbon microphone housing of claim 12, wherein the magnet generating the magnetic field for the ribbon is a bar-type or horseshoe-shaped magnet partially surrounding a first end of the ribbon.

19. The shock-absorbing apparatus of claim 12, further comprising a fabric screen covering a substantial portion of the ribbon, wherein the fabric screen provides a protective layer for the ribbon from external elements and still enables the ribbon to achieve a wide frequency response to the sound waves.

20. The shock-absorbing apparatus of claim 12, further comprising an electrical insulator placed between the ribbon microphone frame and one end of the electrically-conductive spring element, wherein the ribbon microphone frame is electrically grounded.
